(19) United States
(12) Patent Application Publication
(10) Pub. No.: US 2026/0118614 A1
(43) Pub. Date: Apr. 30, 2026

(54) FIBER OPTIC CABLE JACKET WITH HEXAGONAL OR OCTOGONAL SHAPE

(71) Applicant: CORNING RESEARCH & DEVELOPMENT CORPORATION, Corning, NY (US)

(72) Inventors: Peter Stuart Niehoff, Connelly Springs, NC (US); Christopher Mark Quinn, Hickory, NC (US); Rebecca Elizabeth Sistare, Hickory, NC (US)

(21) Appl. No.: 19/428,561

(22) Filed: Dec. 22, 2025

Related U.S. Application Data
(63) Continuation of application No. PCT/US2024/031529, filed on May 30, 2024.
(60) Provisional application No. 63/522,483, filed on Jun. 22, 2023.

(51) Int. Cl. G02B 6/44

(52) U.S. Cl. CPC G02B 6/4429; G02B 6/4486

(57) ABSTRACT

An optical communication cable is provided. Embodiments of the disclosure relate to an optical fiber cable. The optical fiber cable includes an exterior surface and an interior surface, the interior surface defining a bore extending along a length of the cable jacket. The optical fiber cable further includes a cable core disposed within the central bore. In various embodiments, the exterior surface of the cable jacket includes at least six side surfaces. Also disclosed are embodiments of an optical fiber cable having a cable jacket with an ovality of less than eight percent and embodiments of a method of manufacturing an optical fiber cable.

### RELATED APPLICATIONS

This application is a continuation of Internation Patent Application No. PCT/US2024/031529, filed on May 30, 2024, which claims the benefit of priority of U.S. Provisional Patent Application No. 63/522,483, filed on Jun. 22, 2023, the content of which is relied upon and incorporated herein by reference in its entity.

### BACKGROUND

The disclosure relates generally to optical fiber cables and more particularly to optical fiber cable jackets for improved installation. Optical fiber cables have seen an increase in air-assisted (i.e., jetted or blown) cable installations in which air is used to push the optical fiber cable through a passageway or duct to its destination rather than pulling the cable through the duct. The interaction between the optical fiber cable jacket and the duct during installation and the shape of the optical fiber cable impact the distance and speed the cable moves through the duct during installation.

### SUMMARY

According to an aspect, embodiments of the disclosure relate to an optical fiber cable. The optical fiber cable includes a cable jacket and a cable core. The cable jacket includes an exterior surface and an interior surface. The exterior surface defines an outermost surface of the cable jacket. The interior surface defines a central bore extending along a length of the cable jacket. The cable core is disposed within the central bore and includes at least one subunit disposed within the central bore. Each of the at least one subunit including a plurality of optical fibers and each of the at least one subunit being reconfigurable in shape. The exterior surface of the cable jacket includes at least six side surfaces.

According to another aspect, embodiments of the disclosure relate to an optical fiber cable. The optical fiber cable includes a cable jacket and a cable core. The cable jacket includes an exterior surface and an interior surface. The exterior surface defines an outermost surface of the cable jacket. The interior surface defines a central bore extending along a length of the optical fiber cable. The cable core is disposed within the central bore and includes at least one subunit disposed within the central bore. The membrane includes an inner surface defining a central passage that extends along the length of the optical fiber cable and an outer surface. The at least one subunit further includes at least one optical fiber disposed in the central passage such that the membrane surrounds the at least one optical fiber. The cable jacket has an ovality of less than 8%.

According to a further aspect, embodiments of the disclosure relate to a method of manufacturing an optical fiber cable. In the method, a jacket is extruded around a first subunit to form the optical fiber cable. The first subunit includes a plurality of optical fibers surrounded by a membrane. The jacket includes an interior surface and an exterior surface. The exterior surface of the jacket is contacted with a tool to shape the exterior surface into at least six sides.

According to a further aspect, each of the at least one subunit of the cable core includes a membrane. The membrane includes an inner surface defining a central passage that extends along the length of the optical fiber cable, an outer surface and a thickness defined between the inner surface and the outer surface. The thickness is less than 100 microns. The at least one subunit further includes at least one optical fiber disposed in the central passage such that the membrane surrounds the at least one optical fiber.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a cross-sectional view of the cable jacket of an optical fiber cable in a duct, according to an exemplary embodiment.

FIG. 2 is a cross-sectional view of an optical fiber cable in a duct, according to another exemplary embodiment.

FIG. 3 is a cross-sectional view of an optical fiber cable, according to another exemplary embodiment.

FIG. 4 is a flow diagram of a method of forming an optical fiber cable, according to an exemplary embodiment.

### DETAILED DESCRIPTION

Referring generally to the figures, embodiments of an optical fiber cable jacket having specific geometries are shown. The optical fiber cable jacket includes an exterior surface that is multi-sided. Applicant has found that it is desirable to make the cable jacket have a polygonal shape to improve performance for air-assisted (i.e., air jetted or blown) cable installations. Specifically, Applicant has found the cable jacket designs discussed herein allow for increased speed of installation and increased distance of travel of the cable during installation.

In contrast to the cable jacket discussed herein, many optical fiber cables include cable jackets with cross-sections that appear circular, but form more of an oval shape when strength elements are embedded in the cable jacket. During cable installation using an air-assisted method, conventional optical fiber cables may have a diameter as large as 80% of the inner diameter of the duct, with certain geometric variations, such as ovality, reducing the jetting performance. Some optical fiber cables include additional surface features or touch points around the circumference of the cable jacket in an attempt to improve air-assisted installations. These features are typically extruded and require the use of additional material added to the cable jackets and do not prevent reduced performance due to ovality of the optical fiber cables. Applicant believes the lack of additional cable jacket material discussed herein has improved environmental sustainability. In part, the reduction in amount of cable jacket materials reduce the carbon dioxide equivalent of the cable jacket and for the optical cable overall (e.g., reduced cable weight, etc.).

Applicant has found using specific, multi-sided geometries ensures air is able to flow around the optical cable during installation resulting in the optical cable travelling further and faster. Instead of extrusion of additional material around the cable jacket, Applicant has found that post-extrusion molding of the cable jacket to create multi-sided geometries allows for increased control of cable shape that reduces the ovality of the optical fiber cable.

Additionally, as will be discussed in greater detail below, in various embodiments the cable jacket includes at least one strength member embedded in at least one corner between adjacent sides of the cable jacket. Because the corners of the cable jacket receive the most stress and/or force during the installation (i.e., from engagement with the duct), the positioning of the strength member further improves the cable's installation performance.

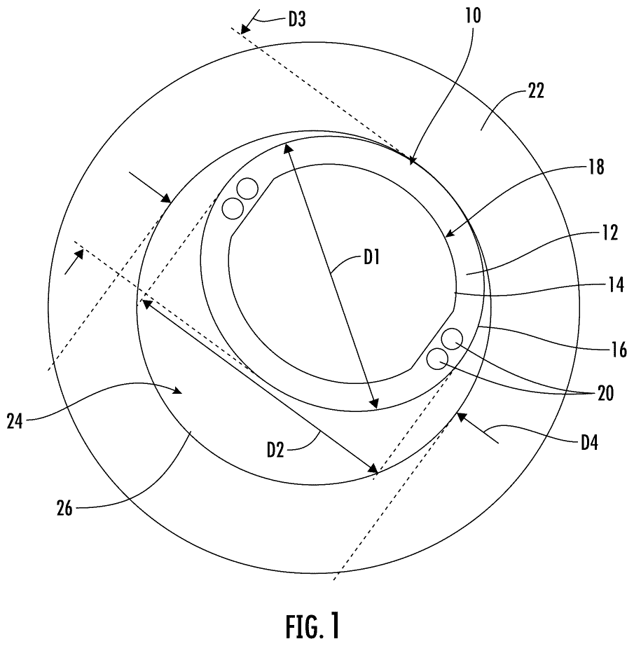

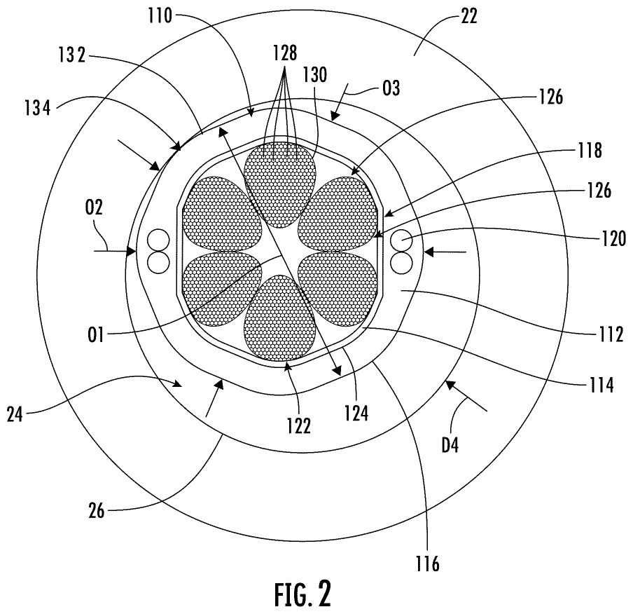

Referring to FIG. 1, various aspects of an optical fiber cable 10 are shown, according to an exemplary embodiment. Optical fiber cable 10 includes a cable jacket 12 having an interior surface 14 and an exterior surface 16. The interior surface 14 of optical fiber cable 10 defines a bore, shown as central bore 18 that extends along a longitudinal axis of the optical fiber cable 10. In various embodiment, disposed within the central bore 18 of the optical fiber cable 10 is a cable core (see e.g., 122 in FIG. 2). In one or more embodiments, the optical fiber cable 10 may include strength members 20. In various embodiments, such strength members 20 are fiber-reinforced plastic rods, yarns, etc. embedded in the cable jacket 12. Optical fiber cable 10 is shown positioned within a passageway or duct 22. Duct 22 includes a central channel 24 defined by an interior surface 26 of duct 22. As optical fiber cable 10 is being installed, optical fiber cable 10 is surrounded by interior surface 26 of duct 22.

As noted above, an important consideration for the air-assisted installation of an optical fiber cable is the difference between the outer dimensions of the cable and the inner dimensions of the duct. Specifically, a fill ratio or the cable diameter/inner diameter of the duct is typically between 40% and 80%. It is desirable to maintain a good installation performance a high fill ratio because some applications require optical fiber cables of a certain size which prevents reducing the outer dimensions of the cables. Installation performance is impacted by the geometry of the cable jacket. As is generally understood, a circular cable jacket is desirable because the circular shape reduces contact between the cable jacket and a duct. In practice, many cables have ovality increasing the surface area contact between the cable jacket and the duct. The percentage ovality of a cable is defined as ((maximum outer diameter-minimum outer diameter)/nominal diameter)×100). In other words, optical fiber cable 10 includes a maximum cross-sectional dimension perpendicular to a length of the cable jacket 12 and a minimum cross-sectional dimension perpendicular to the length of the cable jacket 12. The percentage difference between the maximum cross-sectional dimension and the minimum cross-sectional dimension defines the ovality of optical fiber cable 10.

Cable jacket 12 includes a nominal outer diameter shown as D1, a maximum outer diameter shown as D2, and a minimum outer diameter shown as D3. In a specific embodiment, D1 is equal to 20 mm and D2-D3 is equal to about 2 mm meaning cable jacket 12 has an ovality of 10%. Duct 22 includes a diameter, D4, defined between opposing points on interior surface 26. In a specific embodiment, D4 is 1 inch or 25.4 mm. As shown in FIG. 1, cable jacket 12 has a generally elliptical shape and due to the ovality of 10% the exterior surface 16 nearly matches interior surface 26 of duct 22. Such a close match between the exterior surface 16 of cable jacket 12 and the interior surface 26 of duct 22 means that about 25% of the cable will have near-zero air flow to carry optical fiber cable 10 within duct 22 during air-assisted installation.

Referring to FIG. 2, various aspects of an optical fiber cable 110 are shown, according to an exemplary embodiment. Optical fiber cable 110 includes a cable jacket 112 having an interior surface 114 and an exterior surface 116. The interior surface 114 of optical fiber cable 110 defines a bore, shown as central bore 118 that extends along a longitudinal axis or the length of the optical fiber cable 110. In various embodiments, disposed within the central bore 118 of the optical fiber cable 110 is cable core 122.

In various embodiments, cable core 122 includes a plurality of subunits 126 positioned within central bore 118. Each subunit 126 includes at least one optical fiber 128 surrounded by a membrane 130. In various specific embodiments, each subunit 126 includes a plurality of optical fibers 128. In one or more embodiments, each subunit 126 includes at least 72 optical fibers 128, at least 96 optical fibers 128, or at least 144 optical fibers 128. In one or more embodiments, each subunit 126 includes up to 288 optical fibers 128.

The membrane 130 is a thin and flexible sheath that allows for the subunit 126 to be reconfigured into a variety of different shapes. In various specific embodiments, the membrane 130 and/or subunit 126 has a generally circular shape. In other embodiments, the flexibility of the membrane 130 allows the subunit 126 to change shape, e.g., flatten out, bunch up, or bend, as necessary to fill space within the cable core 122 in contrast to rigid buffer tubes used in other cable designs. In one or more embodiments, the membrane 130 has a thickness of 100 microns or less, for example in a range of 10 microns to 100 microns, in particular in a range of 20 microns to 50 microns. In one or more specific embodiments, a maximum thickness of membrane 130 is 80 microns or less. In one or more specific embodiments, a thickness of membrane 130 is in a range of 40 microns to 70 microns. By contrast, buffer tubes for loose tube cables or ribbon cables have a wall thickness of greater than 100 microns, for example in a range of 150 microns to 2 mm. Further, instead of being reconfigurable, buffer tubes are designed to be rigid and maintain their circular cross-sectional shape.

In other words, cable core 122 is a compressible cable core. In one or more embodiments, cable core 122 does not contain buffer tubes such that the cable core is compressible. In one or more embodiments, the compressible cable core includes various compressible materials such as a foam layer, etc. In one or more embodiments, cable core 122 includes a foam core having a size the same as a size of a subunit 126. In one or more specific embodiments, cable core 122 includes six subunits 126 with a 6 mm foam core positioned in the center or middle of the six subunits 126.

In one or more embodiments, the optical fiber cable 110 further includes a binder 124 provided around the subunits 126, in particular disposed between the subunits 126 and the cable jacket 112. In one or more embodiments, binder 124 is a loose binder. In one or more embodiments, the binder 124 is a polymer film or wrap provided around the subunits 126, which may hold the subunits 126 together in an unstranded configuration. In one or more embodiments, the binder 124 holds subunits 126 together in a stranded configuration (such as S-stranded, Z-stranded, or SZ-stranded). In one or more embodiments, the optical fiber cable 110 includes one or more of a water blocking material (e.g., tapes, yarns, powders), a lubricant, a friction-enhancing material, and an access feature (e.g., ripcords or preferential tear features, such as a strip of dissimilar polymer in the cable jacket 112).

In one or more embodiments, cable core 122 of optical fiber cable 110 includes a threaded bundle of ribbons. For example, in one or more embodiments, cable core 122 includes a bundle of ribbons held together by a polyester thread. In one or more embodiments, cable core 122 includes individual bare or color-coated optical fibers, bunched groups of individual optical fibers, rollable or collapsible ribbons (e.g., ribbons with optical fibers intermittently bonded along the length of the ribbon), or a mixture thereof. In such embodiments, the optical fibers, bunched optical fibers, or ribbons are bound together by a variety of narrow, flexible strips of material, including a strip of a single continuous material or a strip of multiple continuous or discontinuous materials, having the properties described below. For example, in one or more embodiments, the optical elements are bound together by any of various tapes, ribbons, strings, rovings, cords, threads, fibers, filaments, yarns, and twines, among others. Further, in one or more embodiments, the binding material is made from any of a variety of natural or synthetic materials. In one or more embodiments, the binding material includes straight or twisted filaments of a polymer material such as polyester, nylon or natural materials such as cotton, hemp, silk, etc. Advantageously, the threaded bundle of ribbons are also reconfigurable in shape, allowing for the formation of a compressible core.

In one or more embodiments, the optical fiber cable 110 may include strength elements or members 120, such as glass-reinforced plastic rods, embedded in the cable jacket 112. In one or more such embodiments, a first strength member 120 and a second strength member 120 are substantially equidistantly spaced around the cable jacket 112 between interior surface 114 and exterior surface 116. In other words, a first span of cable jacket 112 between the two strength members 120 is substantially equal to a second span of cable jacket 112 between the strength members 120. In one or more embodiments, a third strength member 120 is positioned adjacent to the first strength member 120 and a fourth strength member 120 is positioned adjacent to the second strength member 120. In such an embodiment, the first and third strength members 120 and the second and fourth strength members 120 are positioned such that an outer surface of the respective strength members are touching.

Exterior surface 116 of cable jacket 112 is a multi-sided surface. In one or more embodiments, exterior surface 116 includes at least six side surfaces 132. Side surfaces 132 are outward facing surfaces (i.e., away from cable core 122). In one or more embodiments, exterior surface 116 includes six side surfaces 132. In one or more embodiments, exterior surface 116 includes eight side surfaces 132. In various other embodiments, exterior surface 116 includes a different number of side surfaces 132 greater than six side surfaces (e.g., 7, 8, 9, 10, etc.). Cable jacket 112 further includes at least one corner or corner portion 134. The at least one corner portion 134 is positioned between adjacent side surfaces 132. In one or more embodiments, when there are at least six side surfaces 132 cable jacket 112 also includes at least six corner portions 134. In one or more embodiments, when there are at least eight side surfaces 132 cable jacket 112 also includes at least eight corner portions 134. In various embodiments the number of corner portions 134 is the same as the number of side surfaces 132.

In one or more embodiments, the corner portions 134 include a radius. Applicant has found the large radius of the corner portions 134 of the cable jacket 112 allows the shape of the cable 110 to be close to circular, therefore improving installation performance. In one or more embodiments, the radius of the corner portion 134 is between 2 mm and 8 mm. In one or more specific embodiments the radius of the corner portion 134 at least 2 mm, at least 4 mm, at least 6 mm, or about 8 mm.

Cable jacket 112 includes a nominal outer dimension shown as O1, a maximum outer dimension shown as O2, and a minimum outer dimension shown as O3. In one or more embodiments, cable 110 and/or cable jacket 112 has an ovality of 8% or less, 7% or less, 6% or less, or more preferably 5% or less. In one or more embodiments, cable 110 and/or cable jacket 112 has an ovality less than 6%, less than 5%, or more preferably less than 4%. In a specific embodiment, O1 is equal to 20 mm and O2-O3 is equal to about 0.6 mm meaning cable 110 and/or cable jacket 112 has an ovality of 3%. Diameter, D4, of duct 22 defined between opposing points on interior surface 26 is 1 inch or 25.4 mm. In one or more embodiments, the exact outer dimensions of the cable are adjustable to reach a desired ovality for an optical fiber cable and duct having a different size.

As shown in FIG. 2, cable jacket 112 has a generally polygonal shape and due to the ovality of 3% the exterior surface 116 does not match interior surface 26 of duct 22. The lack of a close match between the exterior surface 116 of cable jacket 112 and the interior surface 26 of duct 22 means that nearly the entire cable 110 can be floated with the compressed air used during air-assisted installation, allowing cable 110 to move further into duct 22 at a faster rate than a cable with a higher ovality. Applicant has found the cables discussed herein can be installed at an 80% faster rate and travel 16% further during air-assisted installation than a conventional cable having an ovality of 8%-10%.

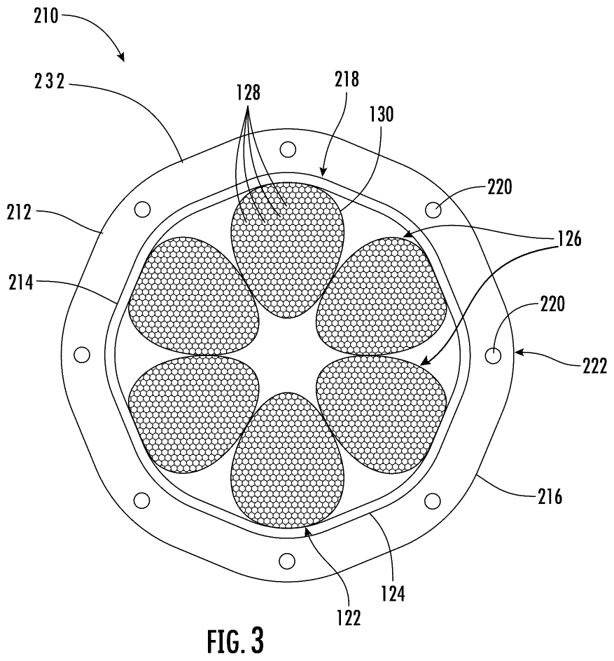

Referring to FIG. 3, various aspects of an optical fiber cable 210 are shown, according to an exemplary embodiment. Optical fiber cable 210 is substantially the same as optical fiber cable 110 except for the differences discussed herein.

As previously discussed, the corner portions of the cable jacket 212 receive stress and/or force during the installation (i.e., from engagement with the duct). The use of strength members 220 adds stiffness to the cable jacket 212 to help offset the mechanical stress caused by installation. Applicant has found positioning of the strength members 220 in the corner portions 222 further improves the cable's installation performance. In one or more embodiments, cable jacket 212 includes a plurality of strength members 220 embedded in cable jacket 212 between the exterior surface 216 and the interior surface 214. In one or more embodiments, a number of the plurality of strength members 220 is the same as a number of the plurality of side surface 232 of cable jacket 212.

Cable jacket 212 includes a plurality of corner portions 222. Each of the plurality of corner portions 222 are positioned between adjacent side surfaces 232 of cable jacket 212. In one or more embodiments, each of the plurality of strength members 220 is positioned at one of the plurality of corner portions 222. In one or more embodiments, the plurality of strength members 220 are substantially equidistantly spaced around cable jacket 212 between interior surface 214 and exterior surface 216.

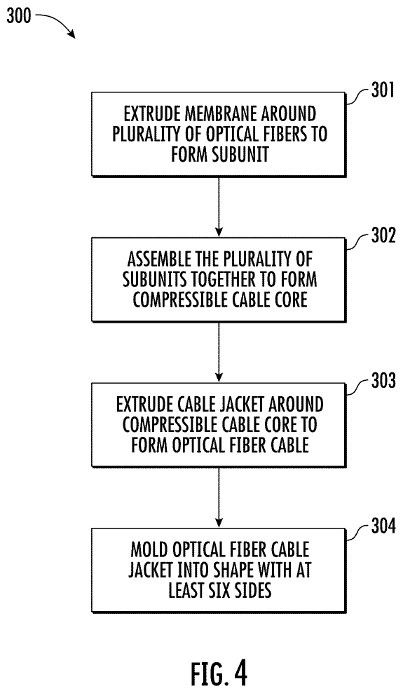

FIG. 4 provides a flow diagram of a method 300 for forming an optical fiber cable 110, 210 according to the present disclosure. In a first step 301 of the method 300, the membrane 130 is extruded around a plurality of optical fibers 128 to form a first subunit 126. In one or more embodiments, a second membrane 130 is extruded around a second plurality of optical fibers 128 to form a second subunit 126. In one or more embodiments, a plurality of membranes 130 are extruded around a plurality of optical fibers 128 to form a plurality of subunits 126. In one or more embodiments, a plurality of optical fibers 128 are grouped together and bound by a material such as tape, ribbons, strings, threads, fibers, yarns, etc. to form a first subunit 126. In such an embodiment, the first subunit 126 is reconfigurable in shape.

In a second step 302 of method 300, the first subunit 126 and the second subunit 126 are grouped together to form a compressible cable core 122. In one or more embodiments, the first subunit 126 and the second subunit 126 are grouped together in an unstranded configuration. In one or more embodiments, a plurality of subunits 126 are grouped together to form a compressible cable core 122.

In a third step 303 of method 300, the cable jacket 112, 212 is extruded around the first subunit 126 to form the optical fiber cable 110, 210. In one or more embodiments, the cable jacket 112, 212 is extruded around the first subunit 126 and the second subunit 126 to form the optical fiber cable 110, 210. In one or more embodiments, the cable jacket 112, 212 is extruded around the plurality of subunits 126 to form the optical fiber cable 110, 210.

In a fourth step 304 of method 300, the exterior surface 116, 216 of the cable jacket 112, 212 is contacted with a tool to shape the exterior surface 116, 216 into at least six sides such that cable jacket 112, 212 has at least six side surfaces 132, 232. In one or more embodiments, the exterior surface 116, 216 of the cable jacket 112, 212 is contacted with a tool to shape or mold the exterior surface 116, 216 into at least eight sides such that cable jacket 112, 212 has at least eight side surfaces 132, 232. In one or more embodiments, the tool is an extrusion die. In one or more embodiments, the tool contacts the exterior surface 116, 216 of the cable jacket 112, 212 within about two feet from the extruder. In one or more embodiments, the tool is positioned within a cooling trough, and shaping of the cable jacket 112, 212 takes place within the cooling trough. As discussed above, Applicant has found the post-extrusion molding of the cable jacket 112, 212 to create multi-sided cable shapes increases geometric control of the cable jacket 112, 212 allowing for reduction in the ovality of the optical fiber cable compared to conventional optical fiber cables.

In one or more embodiments, the method 300 further includes a step of embedding a plurality of strength members 120, 220 in the cable jacket 112, 212 during extrusion of the cable jacket 112, 212. In one or more embodiments, the method further includes positioning the plurality of strength members 120, 220 substantially equidistantly spaced around the compressible cable core 122 and embedding the plurality of strength members 120, 220 in the cable jacket 112, 212 during extrusion. In one or more embodiments, the method further includes choosing a number of strength members 120, 220 to be the same as a number of the at least six side surfaces of the cable jacket 112, 212. In such an embodiment, the method includes embedding the number of strength members 120, 220 in the cable jacket 112, 212 during extrusion. In one or more embodiments, the strength members 120, 220 are formed from materials such as fiber reinforced polymers, fiber glass yarns, Aramid yarns, etc.,

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable comprising:
a cable jacket comprising:
an exterior surface, the exterior surface defining an outermost surface of the cable jacket; and
an interior surface, the interior surface defining a central bore extending along a length of the cable jacket; and
a cable core disposed within the central bore, the cable core comprising:
at least one subunit disposed within the central bore, each of the at least one subunit comprising a plurality of optical fibers and each of the at least one subunit being reconfigurable in shape;
wherein the exterior surface of the cable jacket comprises at least six side surfaces.

2. The optical fiber cable of claim 1, wherein the cable jacket has an ovality of 8% or less.

3. The optical fiber cable of claim 1, wherein the at least six side surfaces comprise eight side surfaces.

4. The optical fiber cable of claim 1, further comprising at least one strength member embedded in the cable jacket between the exterior surface and the interior surface, the strength member extending along the length of the cable jacket.

5. The optical fiber cable of claim 4, wherein the at least one strength member comprises a first strength member and a second strength member, and wherein the first strength member and the second strength member are substantially equidistantly spaced around the cable jacket.

6. The optical fiber cable of claim 1, further comprising at least six corner portions, the at least six corner portions positioned between adjacent side surfaces of the exterior surface.

7. The optical fiber cable of claim 6, further comprising at least six strength members embedded in the cable jacket at the at least six corner portions and between the exterior surface and the interior surface.

8. The optical fiber cable of claim 1, further comprising:
a maximum cross-sectional dimension perpendicular to the length of the cable jacket; and
a minimum cross-sectional dimension perpendicular to the length of the cable jacket; wherein a percentage difference between the maximum cross-sectional dimension and the minimum cross-sectional dimension is less than 8%.

9. An optical fiber cable, comprising:
a cable jacket comprising:
an exterior surface, the exterior surface defining an outermost surface of the optical fiber cable; and
an interior surface, the interior surface defining a central bore extending along a length of the optical fiber cable; and
a cable core disposed within the central bore, the cable core comprising:
at least one subunit disposed within the central bore, each of the at least one subunit comprising:
a membrane comprising:
an inner surface defining a central passage that extends along the length of the optical fiber cable; and
an outer surface; and
at least one optical fiber disposed in the central passage such that the membrane surrounds the at least one optical fiber;
wherein the cable jacket has an ovality less than 8%.

10. The optical fiber cable of claim 9, wherein the exterior surface of the cable jacket comprises at least six side surfaces.

11. The optical fiber cable of claim 9, wherein the exterior surface of the cable jacket comprises at least eight side surfaces.

12. The optical fiber cable of claim 9, wherein the cable core does not contain a buffer tube.

13. The optical fiber cable of claim 9, wherein the at least one subunit comprises a plurality of subunits, and wherein the plurality of subunits extend along the length of the optical fiber cable in an unstranded configuration.

14. The optical fiber cable of claim 9, further comprising a plurality of strength members embedded in the cable jacket between the exterior surface and the interior surface.

15. The optical fiber cable of claim 9, further comprising a plurality of strength members embedded in the cable jacket between the exterior surface and the interior surface, wherein the exterior surface of the cable jacket comprises a plurality of side surfaces and wherein a number of the plurality of strength members is the same as a number of the plurality of side surfaces of the cable jacket.

16. The optical fiber cable of claim 15, wherein the plurality of strength members are substantially equidistantly spaced around the cable jacket.

17. The optical fiber cable of claim 15, the cable jacket further comprising a plurality of corner portions, each of the plurality of corner portions positioned between adjacent side surfaces of the cable jacket.

18. The optical fiber cable of claim 17, wherein each of the plurality of strength members is positioned at one of the plurality of corner portions of the cable jacket.

19. The optical fiber cable of claim 9, wherein the cable jacket has an ovality less than 4%.

20. A method of manufacturing an optical fiber cable, comprising:
extruding a jacket around a first subunit to form the optical fiber cable, the first subunit comprising a plurality of optical fibers surrounded by a membrane, and the jacket comprising an interior surface and an exterior surface; and
contacting the exterior surface of the jacket with a tool to shape the exterior surface into at least six sides.
